(19) United States
(12) Patent Application Publication
(10) Pub. No.: US 2026/0219792 A1
(43) Pub. Date: Jul. 30, 2026

(54) Hidden L0p Exit Latency In Read Workload

(71) Applicant: Sandisk Technologies, Inc., Milpitas, CA (US)

(72) Inventor: Shay BENISTY, Beer Sheva (IL)

(73) Assignee: Sandisk Technologies, Inc., Milpitas, CA (US)

(21) Appl. No.: 19/040,410

(22) Filed: Jan. 29, 2025

(51) Int. Cl. G06F 3/06

(52) U.S. Cl. CPC G06F 3/0625; G06F 3/0659; G06F 3/0689

(57) ABSTRACT

L0p exit latency can be decreased by sending a wake up signal so that the lane(s) of the link wake up just in time for data to be transmitted thereover. After parsing and scheduling a read command, the controller can determine the number of lanes needed to deliver the read data to the host device. If there are any lanes that need to be woken up from an electrically idle state, the wake up signal can be sent before the data is ready to transmit. The wake up signal is sent at a time equal to the L0p exit latency time provided by the host device. The time may be adjusted based upon measured L0p exit latency time. Additionally, the time can be coordinated with a timer in a L0p manager module or in coordination with events that occur when executing the read command.

### BACKGROUND OF THE DISCLOSURE

### Field of the Disclosure

Embodiments of the present disclosure generally relate to improving exit L0p latency when processing commands.

### Description of the Related Art

For high speed data communications, data transfer rates and power efficiency are receiving more and more attention. The L0p state was introduced to address the limitations of L0s and provide more flexibility and efficiency in power management for peripheral component interconnect (PCI) express (PCIe) 6.0. The L0p state is a power management state designed to improve the flexibility and efficiency of PCIe links, especially in scenarios where dynamic adaptability are needed. Some of the key points of L0p are: optional power management state, selective lane activation, dynamic link width adjustment, and dynamic link width with reduced delay.

Optional power management state in L0p is an optional state for the link, and is specifically designed for fixed sized flow control unit (FLIT) mode. Selective lane activation in L0p allows a link to have some lanes of the link active while other lanes of the link remain in an idle state. The selective activation helps reduce power consumption while maintaining link symmetry. For dynamic link width adjustment, once the handshaking is completed, the link can dynamically downgrade or upgrade the link width based on requirements. The flexibility is a significant advantage of L0p. Dynamic link width with reduced delay in L0p allows for dynamic changes in link width without introducing significant delay. By keeping only a few lanes active, power consumption is reduced, and power scales with bandwidth.

As noted above, L0p state in PCIe 6.0 is a significant enhancement that overcomes the limitations of L0s. The L0p state's ability to dynamically adjust link width, support FLIT mode, and maintain power efficiency makes L0p state a valuable addition to the PCIe ecosystem. As technology continues to advance, innovations like L0p play a crucial role in optimizing performance while minimizing power consumption.

There is no impact to traffic flow with either entry or exit of L0p since PCIe uses the existing periodic synchronization buffer (SKP) ordered set to orchestrate when a lane switches to an inactive state (i.e., width down configuration) or enters into the mix of other active lanes sending traffic (i.e., width up configuration). Once a determination is made to reduce the link width with L0p, one must wait until the next SKP ordered set boundary, which in the worst case will be 1.5 micro-seconds away. On the way to up-configure, the wait will be identical to L1 exit latency, which is dependent on the design and the amount of aggressive power savings the device implements. PCIe expects the latency number to be in the micro-seconds range, but the latency exists nonetheless.

Therefore, there is a need in the art for decreasing L0p exit latency.

### SUMMARY OF THE DISCLOSURE

L0p exit latency can be decreased by sending a wake up signal so that the lane(s) of the link wake up just in time for data to be transmitted thereover. After parsing and scheduling a read command, the controller can determine the number of lanes needed to deliver the read data to the host device. If there are any lanes that need to be woken up from an electrically idle state, the wake up signal can be sent before the data is ready to transmit. The wake up signal is sent at a time equal to the L0p exit latency time provided by the host device. The time may be adjusted based upon measured L0p exit latency time. Additionally, the time can be coordinated with a timer in a L0p manager module or in coordination with events that occur when executing the read command.

In one embodiment, a data storage device comprises: a memory device; and a controller coupled to the memory device, wherein the controller is configured to: record L0p exit latency of link partner, wherein the exit latency is a first period of time; initiate L0p request to save power; determine that data needs to be transferred to the link partner; initiate L0p exit request, wherein the initiation occurs at a second period of time, wherein the second period of time is before transferring the data to the link partner, and wherein the second period is equal to or greater than the first period of time; and transfer the data to the link partner.

In another embodiment, a data storage device comprises: a memory device; and a controller coupled to the memory device, wherein the controller is configured to: maintain a link between a host interface module (HIM) and a host device, wherein the link comprises a plurality of lanes and wherein the link has an exit latency; determine whether one or more lanes of the plurality of lanes needs to be woken up; send a L0p exit request to the host device, wherein the sending occurs at a first point in time; and transfer data to the host device, wherein the transferring occurs as a second point in time, and wherein a difference between the second point in time and the first point in time is equal to or greater than the exit latency.

In another embodiment, a data storage device comprises: means for storing data; and a controller coupled to the means for storing data, wherein the controller is configured to: parse and schedule a read command; compare L0p exit latency to values in a table containing time before seeing traffic on a link; determine a point in time for sending a L0p exit request to a host device, wherein the point in time is during execution of the read command and before data for the read command reaches a host interface module (HIM); send the L0p exit request to the host device; and send the data for the read command to the host device.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic block diagram illustrating a storage system in which a data storage device may function as a storage device for a host device, according to certain embodiments.

FIG. 2 is a schematic diagram illustrating an example of L0p flow in a sixteen link system according to certain embodiments.

FIG. 3 is a schematic illustration of a data link feature capability structure focusing on L0p exit latency according to one embodiment.

FIG. 4 is a schematic illustration of a data storage system according to one embodiment.

FIG. 5 is a flowchart illustrating hidden L0p exit latency in a read workload according to one embodiment.

FIGS. 6A and 6B are collectively a flowchart illustrating read command processing according to one embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specifically described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

L0p exit latency can be decreased by sending a wake up signal so that the lane(s) of the link wake up just in time for data to be transmitted thereover. After parsing and scheduling a read command, the controller can determine the number of lanes needed to deliver the read data to the host device. If there are any lanes that need to be woken up from an electrically idle state, the wake up signal can be sent before the data is ready to transmit. The wake up signal is sent at a time equal to the L0p exit latency time provided by the host device. The time may be adjusted based upon measured L0p exit latency time. Additionally, the time can be coordinated with a timer in a L0p manager module or in coordination with events that occur when executing the read command.

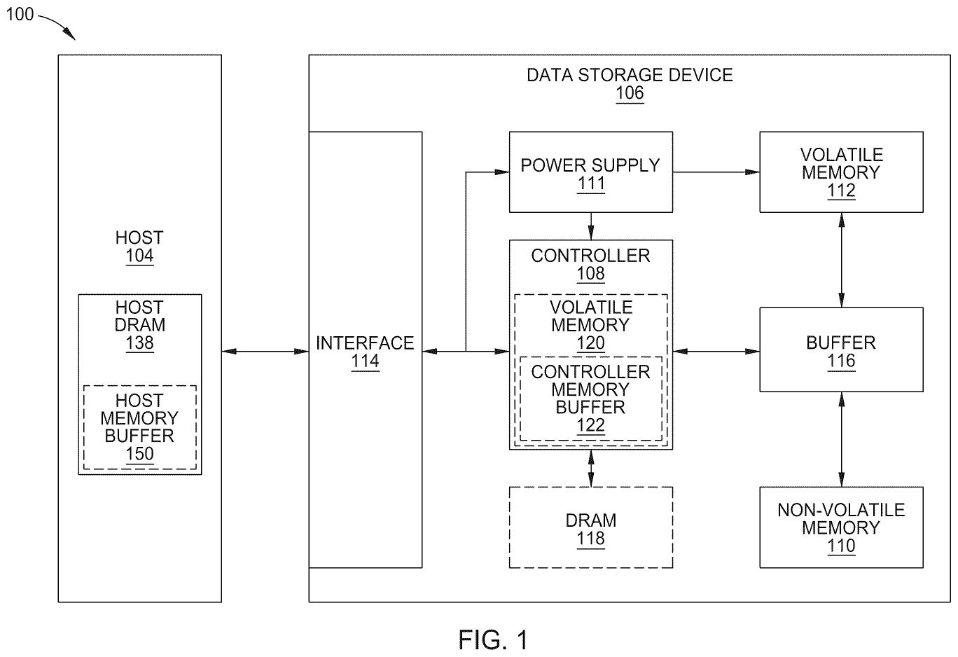

FIG. 1 is a schematic block diagram illustrating a storage system 100 having a data storage device 106 that may function as a storage device for a host device 104, according to certain embodiments. For instance, the host device 104 may utilize a non-volatile memory (NVM) 110 included in data storage device 106 to store and retrieve data. The host device 104 comprises a host dynamic random access memory (DRAM) 138. In some examples, the storage system 100 may include a plurality of storage devices, such as the data storage device 106, which may operate as a storage array. For instance, the storage system 100 may include a plurality of data storage devices 106 configured as a redundant array of inexpensive/independent disks (RAID) that collectively function as a mass storage device for the host device 104.

The host device 104 may store and/or retrieve data to and/or from one or more storage devices, such as the data storage device 106. As illustrated in FIG. 1, the host device 104 may communicate with the data storage device 106 via an interface 114. The host device 104 may comprise any of a wide range of devices, including computer servers, network-attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or other devices capable of sending or receiving data from a data storage device.

The host DRAM 138 may optionally include a host memory buffer (HMB) 150. The HMB 150 is a portion of the host DRAM 138 that is allocated to the data storage device 106 for exclusive use by a controller 108 of the data storage device 106. For example, the controller 108 may store mapping data, buffered commands, logical to physical (L2P) tables, metadata, and the like in the HMB 150. In other words, the HMB 150 may be used by the controller 108 to store data that would normally be stored in a volatile memory 112, a buffer 116, an internal memory of the controller 108, such as static random access memory (SRAM), and the like. In examples where the data storage device 106 does not include a DRAM (i.e., optional DRAM 118), the controller 108 may utilize the HMB 150 as the DRAM of the data storage device 106.

The data storage device 106 includes the controller 108, NVM 110, a power supply 111, volatile memory 112, the interface 114, a write buffer 116, and an optional DRAM 118. In some examples, the data storage device 106 may include additional components not shown in FIG. 1 for the sake of clarity. For example, the data storage device 106 may include a printed circuit board (PCB) to which components of the data storage device 106 are mechanically attached and which includes electrically conductive traces that electrically interconnect components of the data storage device 106 or the like. In some examples, the physical dimensions and connector configurations of the data storage device 106 may conform to one or more standard form factors. Some example standard form factors include, but are not limited to, 3.5″ data storage device (e.g., an HDD or SSD), 2.5″ data storage device, 1.8″ data storage device, peripheral component interconnect (PCI), PCI-extended (PCI-X), PCI Express (PCIe) (e.g., PCIe×1, ×4, ×8, ×16, PCIe Mini Card, MiniPCI, etc.). In some examples, the data storage device 106 may be directly coupled (e.g., directly soldered or plugged into a connector) to a motherboard of the host device 104.

Interface 114 may include one or both of a data bus for exchanging data with the host device 104 and a control bus for exchanging commands with the host device 104. Interface 114 may operate in accordance with any suitable protocol. For example, the interface 114 may operate in accordance with one or more of the following protocols: advanced technology attachment (ATA) (e.g., serial-ATA (SATA) and parallel-ATA (PATA)), Fibre Channel Protocol (FCP), small computer system interface (SCSI), serially attached SCSI (SAS), PCI, and PCIe, non-volatile memory express (NVMe), OpenCAPI, GenZ, Cache Coherent Interface Accelerator (CCIX), Open Channel SSD (OCSSD), or the like. Interface 114 (e.g., the data bus, the control bus, or both) is electrically connected to the controller 108, providing an electrical connection between the host device 104 and the controller 108, allowing data to be exchanged between the host device 104 and the controller 108. In some examples, the electrical connection of interface 114 may also permit the data storage device 106 to receive power from the host device 104. For example, as illustrated in FIG. 1, the power supply 111 may receive power from the host device 104 via interface 114.

The NVM 110 may include a plurality of memory devices or memory units. NVM 110 may be configured to store and/or retrieve data. For instance, a memory unit of NVM 110 may receive data and a message from controller 108 that instructs the memory unit to store the data. Similarly, the memory unit may receive a message from controller 108 that instructs the memory unit to retrieve data. In some examples, each of the memory units may be referred to as a die. In some examples, the NVM 110 may include a plurality of dies (i.e., a plurality of memory units). In some examples, each memory unit may be configured to store relatively large amounts of data (e.g., 128 MB, 256 MB, 512 MB, 1 GB, 2 GB, 4 GB, 8 GB, 16 GB, 32 GB, 64 GB, 128 GB, 256 GB, 512 GB, 1 TB, etc.).

In some examples, each memory unit may include any type of non-volatile memory devices, such as flash memory devices, phase-change memory (PCM) devices, resistive random-access memory (ReRAM) devices, magneto-resistive random-access memory (MRAM) devices, ferroelectric random-access memory (F-RAM), holographic memory devices, and any other type of non-volatile memory devices.

The NVM 110 may comprise a plurality of flash memory devices or memory units. NVM Flash memory devices may include NAND or NOR-based flash memory devices and may store data based on a charge contained in a floating gate of a transistor for each flash memory cell. In NVM flash memory devices, the flash memory device may be divided into a plurality of dies, where each die of the plurality of dies includes a plurality of physical or logical blocks, which may be further divided into a plurality of pages. Each block of the plurality of blocks within a particular memory device may include a plurality of NVM cells. Rows of NVM cells may be electrically connected using a word line to define a page of a plurality of pages. Respective cells in each of the plurality of pages may be electrically connected to respective bit lines. Furthermore, NVM flash memory devices may be 2D or 3D devices and may be single level cell (SLC), multi-level cell (MLC), triple level cell (TLC), or quad level cell (QLC). The controller 108 may write data to and read data from NVM flash memory devices at the page level and erase data from NVM flash memory devices at the block level.

The power supply 111 may provide power to one or more components of the data storage device 106. When operating in a standard mode, the power supply 111 may provide power to one or more components using power provided by an external device, such as the host device 104. For instance, the power supply 111 may provide power to the one or more components using power received from the host device 104 via interface 114. In some examples, the power supply 111 may include one or more power storage components configured to provide power to the one or more components when operating in a shutdown mode, such as where power ceases to be received from the external device. In this way, the power supply 111 may function as an onboard backup power source. Some examples of the one or more power storage components include, but are not limited to, capacitors, super-capacitors, batteries, and the like. In some examples, the amount of power that may be stored by the one or more power storage components may be a function of the cost and/or the size (e.g., area/volume) of the one or more power storage components. In other words, as the amount of power stored by the one or more power storage components increases, the cost and/or the size of the one or more power storage components also increases.

The volatile memory 112 may be used by controller 108 to store information. Volatile memory 112 may include one or more volatile memory devices. In some examples, controller 108 may use volatile memory 112 as a cache. For instance, controller 108 may store cached information in volatile memory 112 until the cached information is written to the NVM 110. As illustrated in FIG. 1, volatile memory 112 may consume power received from the power supply 111. Examples of volatile memory 112 include, but are not limited to, random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, LPDDR4, and the like)). Likewise, the optional DRAM 118 may be utilized to store mapping data, buffered commands, logical to physical (L2P) tables, metadata, cached data, and the like in the optional DRAM 118. In some examples, the data storage device 106 does not include the optional DRAM 118, such that the data storage device 106 is DRAM-less. In other examples, the data storage device 106 includes the optional DRAM 118.

Controller 108 may manage one or more operations of the data storage device 106. For instance, controller 108 may manage the reading of data from and/or the writing of data to the NVM 110. In some embodiments, when the data storage device 106 receives a write command from the host device 104, the controller 108 may initiate a data storage command to store data to the NVM 110 and monitor the progress of the data storage command. Controller 108 may determine at least one operational characteristic of the storage system 100 and store at least one operational characteristic in the NVM 110. In some embodiments, when the data storage device 106 receives a write command from the host device 104, the controller 108 temporarily stores the data associated with the write command in the internal memory or write buffer 116 before sending the data to the NVM 110. Controller 108 may include circuitry or processors configured to execute programs for operating the data storage device 106.

The controller 108 may include an optional second volatile memory 120. The optional second volatile memory 120 may be similar to the volatile memory 112. For example, the optional second volatile memory 120 may be SRAM. The controller 108 may allocate a portion of the optional second volatile memory to the host device 104 as controller memory buffer (CMB) 122. The CMB 122 may be accessed directly by the host device 104. For example, rather than maintaining one or more submission queues in the host device 104, the host device 104 may utilize the CMB 122 to store the one or more submission queues normally maintained in the host device 104. In other words, the host device 104 may generate commands and store the generated commands, with or without the associated data, in the CMB 122, where the controller 108 accesses the CMB 122 in order to retrieve the stored generated commands and/or associated data.

The instant disclosure addresses the issue of exit latency from the L0p state. As mentioned previously, the exit latency ranges within several microseconds, which can still potentially impact performance if not properly managed. The disclosure details how memory devices can utilize the L0p state while effectively concealing exit latency, particularly in read workloads.

The main advantage of the L0p is that the controller can dynamically change the link width. Specifically, how many active and how many electrically idle lanes between the host device and the data storage device. The change can occur dynamically with flow latency. The number of lanes can be reduced ‘immediately’, and correspondingly the number of lanes can be increased ‘immediately’ where ‘immediately’ is understood to be with very low latency which is the main advantage of the L0p feature. However, ‘immediately’ does take some time, on the order of microseconds. It is true that ‘immediately’ is faster compared to the past when a change in links involved wasting a lot of time. Even though the exit latency in L0p is in the microsecond range, it would be beneficial to optimize the exit latency and not lose performance just because of the switching between active and non-active lanes.

As discussed herein, the disclosure proposes the idea of concealing the L0p exit latency by sending out L0p exit requests ahead of time. The timing of the exit requests is determined by the advertised L0p exit latency of the specific link and the actual measured exit timings from past occurrences. The approach involves incorporating several events in the data path, with each event reporting upcoming traffic and corresponding timing.

As discussed herein, the device controller optimizes performance and power consumption by effectively utilizing the L0p feature. The optimization is achieved by triggering the L0p exit request ahead of time, taking into account the L0p exit latency advertised by the host link partner.

The idea is to hide the exit latency. From the host point of view, the host will not see any performance degradation. The data storage device will still utilize the L0p feature. The data storage device will wake up the system and ask the host for example, to increase the number of active lanes ahead of time in order to hide the exit latency.

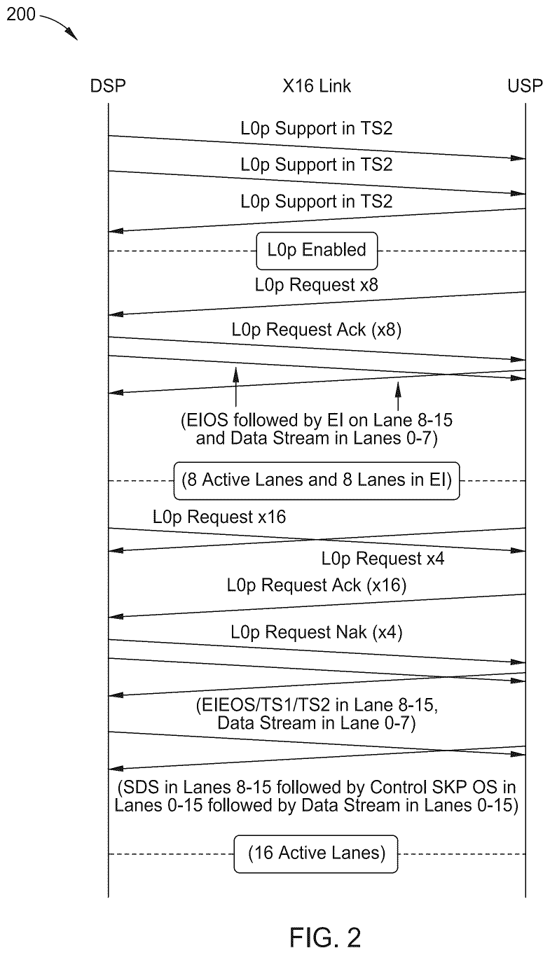

FIG. 2 is a schematic diagram 200 illustrating an example of L0p flow in a sixteen link system according to certain embodiments where there is a downstream port (DSP) and an upstream port (USP). It is to be noted that this is just one example. At the beginning, there is a link of sixteen lanes, and the lanes and L0p are advertised as supported by both sides. Then, after the negotiation that both sides know SLP is enabled, the USP in this example asks the DSP to reduce the number of lanes to eight. Then the DSP sends the acknowledgement and after some time there are some packets sent over the link. The DSP then asks to increase the number of lanes while the USP, not seeing sufficient activity, wants to decrease the number of lanes. According to the standard, when one port wants to increase the number of lanes and another port wants to decrease the number of lanes, the port that will win is the port that wants to increase and therefore there will be an acknowledgement of the increase in the number of lanes and a not acknowledgement (i.e., Nak) for the decrease in the number of lanes.

More specifically, initially, L0p is enabled on the link during the configuration complete state. The USP requests the link to downsize to ×8 which is acknowledged by the DSP. On the next SKP ordered set, the L0p indication is provided by the port on a per-lane basis. For example, lanes 0-7 continue with the traffic whereas lanes 8-15 send an EIOSQ and go to electrical Idle. Thus, the link now has eight active lanes and eight lanes in idle state. At a later point, the DSP requests upsizing the link to sixteen lanes while the USP has made a request to further downsize to four active lanes. The four active lane request gets not-acknowledged, and the sixteen active lane request gets acknowledged. Then, link training proceeds in lanes 8-15, initiated by the DSP with the exchange of TS1/TS2 ordered sets with EIEOS inserted at appropriate intervals. When lanes 8-15 are ready, an SDS is sent immediately preceding the next scheduled SKP ordered set in the lanes. The link operates as a sixteen lane link after sending the SKP ordered set across all sixteen lanes. Even though L0p is symmetric during the transitions, the two sides may be operating at different widths for a while.

The data link feature capability is an optional extended capability that is required for DSPs that support one or more of the associated features. Using the capability, each device on a link advertises their L0p exit latency during the data link feature DLLP exchange. Each device records the L0p exit latency of the link partner and uses that to decide whether to enter L0p state and when to exit.

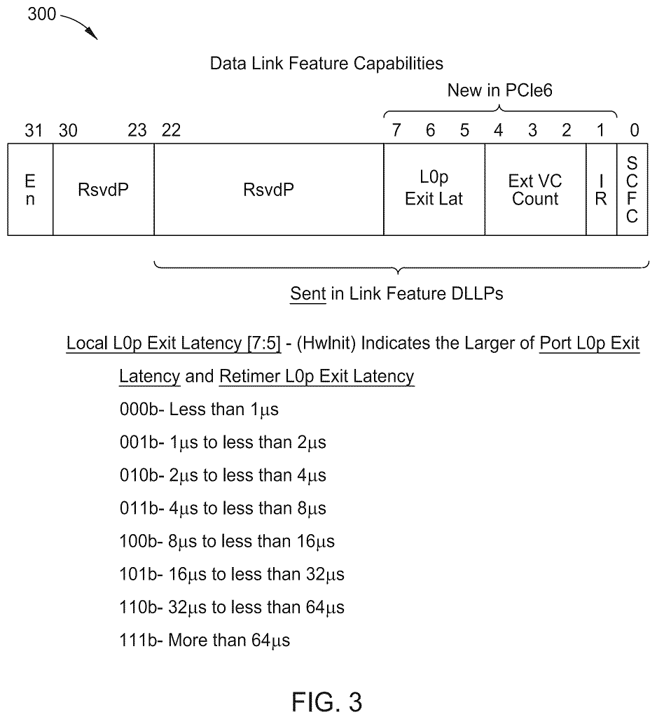

FIG. 3 is a schematic illustration of a data link feature capability structure 300 focusing on L0p exit latency according to one embodiment. FIG. 3 illustrates the structure of the data link feature capability register while focusing on the L0p exit latency field. As noted above, there is a negotiation between the ports and a telling that the L0p feature is supported. The ports also deliver some attributes in between them that are relevant to the L0p feature. As part of the exchange, each port tells the other port the exit latency from L0p state. As shown in FIG. 3, there is a register and those are the fields that could be less. For example, if the value is 0, it means less than one microsecond. If the value is 4, for example, the exit latency would be 8 microseconds. Each port advertises to the other port the exit latency at the beginning. The advertising can be used to reduce the power and make the system more efficient.

As noted above, even waiting for the ‘immediately’ available link can be too long to wait. The idea is to wake up the other side ahead of time. For example, if one side knows the other side will take up to 16 microsecond to wake up everything and be in full active mode, the wake up request can be sent ahead of time, such as 16 microsecond before. Doing so will give the other side enough time to wake up and be ready for the full transfer just on time.

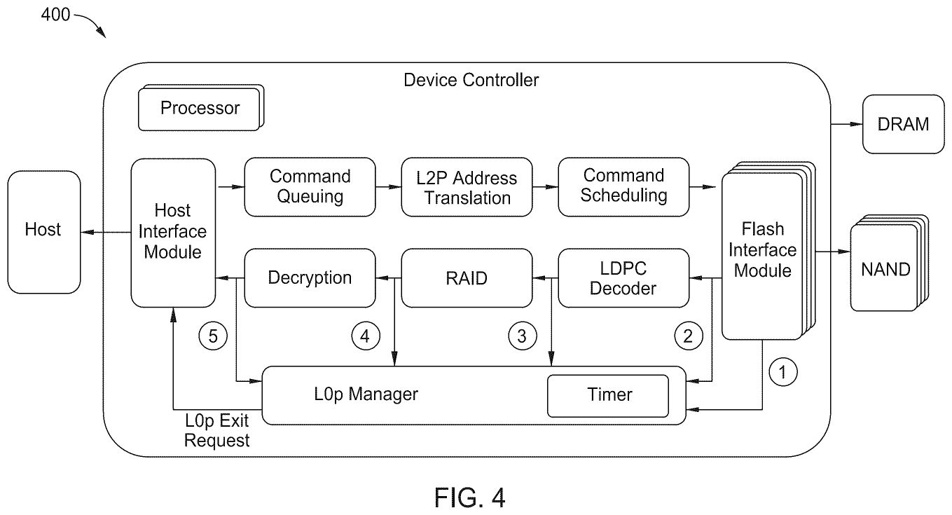

FIG. 4 is a schematic illustration of a data storage system 400 according to one embodiment. The device controller incorporates the new L0p manager module. The module collects some information from the different engines regarding the upcoming traffic. Based on the information along with the advertised L0p exit latency of the link partner, the L0p manager manages the L0p entry and exit timing. The logic also implements a timer to mimic the sense time operation.

The L0p manager receives information from the engines. For example, when the decryption completes, the decryption module updates the L0p manager module regarding the time to perform the decryption. Similarly, after the RAID completes, the RAID module and LDPC decoder also update the L0p manager module. For the flash interface module (FIM), the FIM will update the L0p manager module regarding how long the sense operation on the memory device (e.g., NAND) takes. The updates are provided because there is a table maintained in the L0p manager module.

For example, when there is entry to the HIM from the decryption module, there may be 1 uSec before sending the actual data over the link between the decryption module and the HIM. Due to the latency, the time from the completion of the decryption in the decryption module and when the data is seen in the HIM is 1 uSec. If, for example, the exit latency that the host advertised at the beginning is that it takes less than 1 uSec to wake up the non active lanes, then the event of sending data between the decryption module and the HIM will be used in order to wake up the host. However, if, for example, the host advertised more time needed in order to wake up everything, then a different event would be used.

If there is a mismatch between the time before seeing the traffic on the link and the advertised time to activate a link, a timer can be used. The timer is implemented in the L0p manager module. The timer is beneficial because the data storage device doesn't have sufficient granularity to have the exact time advertised. For example, if the exit latency is known for a specific host to be 40 uSec, but the sense time is 70 uSec, the data storage device cannot send the wakeup request to the host because to wake up the system earlier is not efficient from a power point of view. Therefore, the timer can be implemented and based on the timer, activating occurs based on the value of 40 uSec. Thus, the timer provides better granularity as to when to wake up the host.

The L0p manager may receive information for the following events, for example: the FIM reports about the upcoming transfer at three points (sense time; start NAND transfer time; and end NAND transfer time); entry to LDPC decoder; entry to RAID logic; entry to decryption logic; and entry to the HIM. Based on those events along with the advertised L0p exit latency of the link partner, the L0p manager module manages the L0p entry and exit timing. The following table shows one example of the timing of the events. The table shows per event how much time before monitoring the traffic on the link, the event is triggered.

| | Time before seeing the | |
|---|---|---|
| Event | traffic on the link | |
| Sense time | 70 | uSec |
| Start NAND transfer time | 10 | uSec |
| End NAND transfer time | 9 | uSec |
| Entry to LDPC decoder module | 8 | uSec |
| Entry to RAID module | 4 | uSec |
| Entry to decryption module | 2 | uSec |
| Entry to HIM | 1 | uSec |

If the advertised L0p exit latency of the link partner is 1 uSec, the L0p manager uses the event from the HIM. If the L0p exit latency advertised is 2 uSec, the event from the decryption module is taken. If the LOP exit latency is 32 uSec, the event from the sense time is taken while activating the internal timer to detect the exact timing when to send the wakeup request.

In operation, first of all, the data storage device fetches the read command from the host and after some time will fetch the data from the memory device (e.g., NAND) after command passing and scheduling. Assume for example that there is only one command in the system. After some time the L0p manager module will see the sense request over the NAND. This is event number 1 in FIG. 4. After some more time, it takes usually 50 microseconds, the controller will fetch the data from the NAND and then after sometime the L0p manager module will see the event. Data transfer from the film FIM to the LDPC module is event number 2 in FIG. 4. The same will occur for events 3-5 in FIG. 4. Based on the events and the time that was advertised at the beginning, the L0p manager module knows how much time is needed to wake up the host before the full performance over the link is needed. Additionally, the full performance is needed on the interface between the host and the HIM. It means after the controller fetches the data from the NAND, the data is passed to the LDPC decoder module, the RAID module, the decryption module, and the HIM. Only at this point will full performance of the host interface be needed.

It is to be noted that the full data transfer can occur without increasing the number of active lanes. For example, after command fetching and parsing, the controller can decide whether there is a need to increase the number of active lanes or not. The controller may decide that the data transfer and enough performance can occur even without increasing the number of active links.

Consider now another example in coordination with the above Table. If the advertised L0p exit latency is 12 uSec, then the only event in the Table that is sufficiently long enough to hide the exit latency is the sense time of 70 uSec. However, 70 uSec is too long and thus would lead to inefficiencies from a power point of view. The timer could be used so that 58 uSec after the sense time has begun, the L0p exit signal can be sent and thus the L0p exit latency is hidden.

Now consider that the read command will result in the use of the HIM, decryption module, RAID module, LDPC decoder, and FIM. Also, consider the same advertised exit latency of 12 uSec. The entry to the HIM is 1 uSec, the entry to the decryption module is 2 uSec, the entry to RAID module is 4 uSec, and the entry to the LDPC decoder is 8 uSec. Collectively, the entries add up to 15 uSec. However, 15 uSec is too long and thus would lead to inefficiencies from a power point of view. The timer could be used so that 3 uSec after the entry to the LDPC decoder, the L0p exit signal can be sent and thus the L0p exit latency is hidden.

Again consider that the read command will result in the use of the HIM, decryption module, RAID module, LDPC decoder, and FIM. Also, consider an advertised exit latency of 50 uSec. The entry to the HIM is 1 uSec, the entry to the decryption module is 2 uSec, the entry to RAID module is 4 uSec, and the entry to the LDPC decoder is 8 uSec, the end of NAND transfer time is 9 uSec, and the start of NAND transfer time is 10 uSec. Collectively, the entries add up to 34 uSec. However, 34 uSec is not long enough and thus still would lead to inefficiencies from a power point of view. The sense time is 70 uSec, which by itself is longer than the needed 50 uSec. When added to the other values from the Table collectively results in 104 uSec, which is too long and thus would also lead to inefficiencies from a power point of view. The timer could be used so that 54 uSec after the sense time has begun, the L0p exit signal can be sent and thus the L0p exit latency is hidden.

Because the data will pass through the FIM, HIM, RAID module, LDPC decoder, and decryption module, each of the events listed in the table will occur. As such, each of the time values in the table will occur. Thus, if there is a 70 uSec exit latency, sending the exit signal at the beginning of the sense time will result in a lane being active for 34 uSec earlier than needed, which is inefficient from a power point of view. The 34 uSec is due to the data passing through the FIM, HIM, RAID module, LDPC decoder, and decryption module. It is to be understood that more or less events than listed in the Table may be present. The point is that whatever events occur, and the time for those events, can be factored in to determining when to send the exit signal to ensure maximizing the benefits of L0p while minimizing latency.

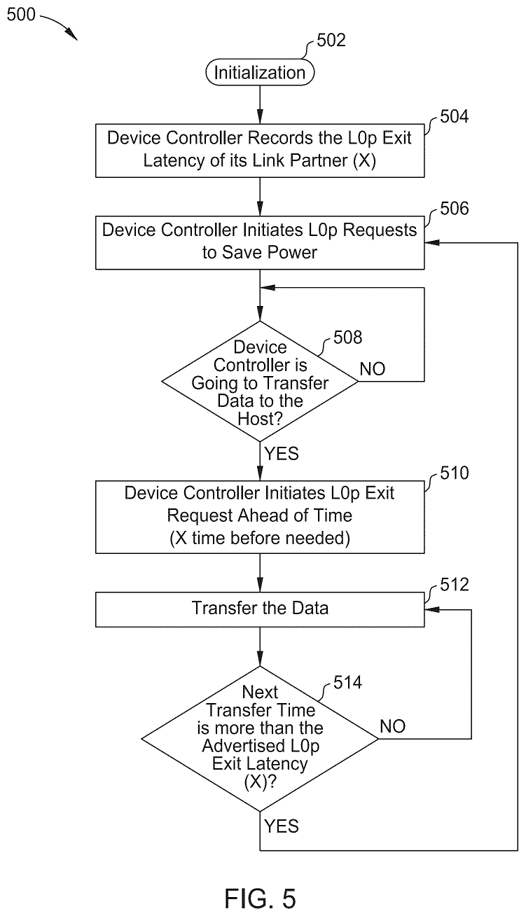

FIG. 5 is a flowchart 500 illustrating hidden L0p exit latency in a read workload according to one embodiment. After initialization, the link partner advertises the L0p exit latency. The device controller enters L0p state only when the next transfer will not be in the next L0p exit window. Additionally, the controller will trigger L0p exit latency ahead of time considering the advertised L0p exit latency.

Generally speaking, one side tells the other side the expected latency, and the controller records the information and keeps the information internally. The device controller initiates a L0p request to save power and reduce the number of active lanes. Then device controller is going to transfer data to the host and checks whether it is appropriate to stay in the state. Otherwise, the device controller will initiates L0p exit request ahead of time based on the time recorded from the other link at the beginning. Based on the recorded information, the host will wake up the needed link ahead of time, and then the data is transferred. While the data is ready to be transferred, the assumption is that there will be full alignment and all the relevant links will be up. Then, if the next data transfer time is not more than the advertised L0p exit latency, the device will stay in the mode, otherwise the controller will again send a request to the other link to reduce the number of lanes.

More specifically in regards to FIG. 5, the process begins at initialization at block 502 followed by the device controller recording the L0p exit latency of the link with the partner (i.e., host device) at block 504. The latency is “X”. The device controller then initiates L0p requests to save power at block 506. At some point in time, the device controller will determine whether there will be a need to transfer data to a host device at block 508. If there is no need to transfer data, then the process repeats at block 508, but if there will be a need, the device controller initiates L0p exit request ahead of time at block 510 and transfers the data at block 512. The ‘ahead of time’ will be the latency value “X”. After transferring the data, the controller determines at block 514 whether the next transfer time is more than the advertised L0p exit latency (i.e., “X”). If not greater than “X”, the process proceeds to block 512, but if yes then the process proceeds to block 506.

In another embodiment, device controller does not just rely on the advertisement from the host. The controller also correlates exit latency with the actual exit time measured on the link. The actual numbers will feed the algorithm and fine tune the algorithm to be better aligned with the real results.

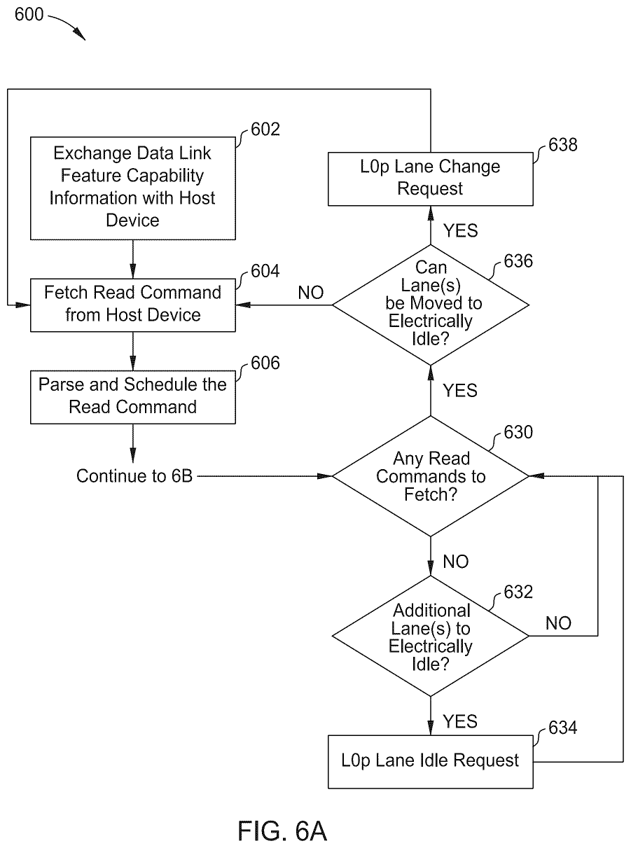

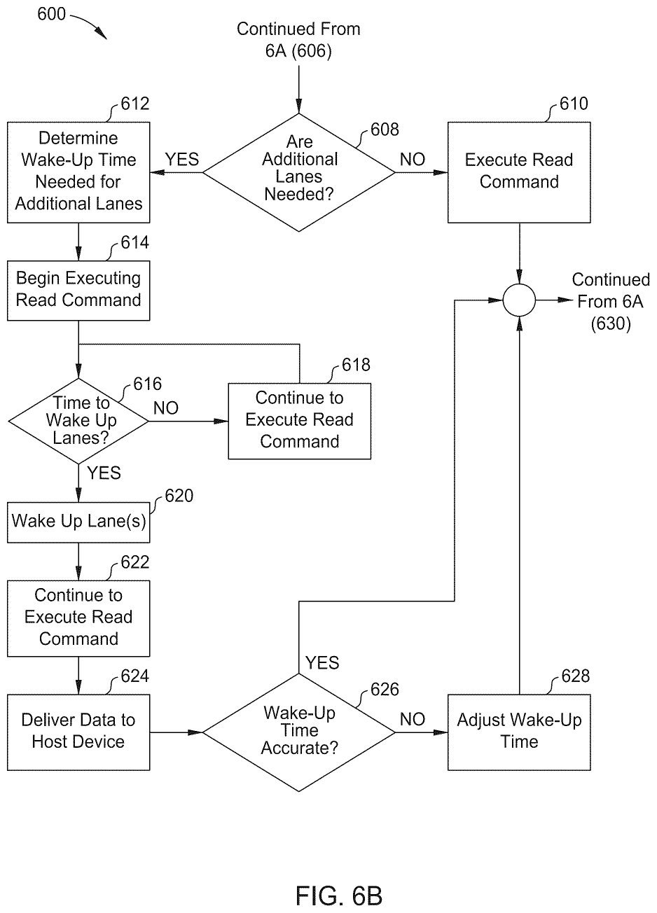

FIGS. 6A and 6B are collectively a flowchart 600 illustrating read command processing according to one embodiment. Initially, the host device and the data storage device exchange data link feature capability information at block 602. The information will include the L0p exit latency. Thereafter, at some point in time, the host device will issue a read command, and the data storage device will fetch the read command from the host device at block 604. The controller of the data storage device will parse and schedule the read command at block 606. Based upon the parsing, the controller will determine whether any additional lanes (oftentimes referred to as links) are needed at block 608. If no additional lanes are needed, the read command is simply executed at block 610.

If, however, additional lanes are needed, then the controller determines the wake-up time needed for the additional lane(s) at block 612. The determination is made by retrieving the L0p exit latency information provided by the host device at block 602 and stored by the data storage device. The controller also starts executing the read command at block 614. It is to be understood that blocks 612 and 614 can occur in any order or simultaneously.

Thereafter, the controller, or more specifically the L0p manager module, determines whether it is time to wake up the lane(s) at block 616. If it is not time, then the controller continues to execute the read command at block 618 and then returns to block 616. If it is time, then the L0p manager module wakes up the lane(s) at block 620 and the controller continues to execute the read command at block 622. It is to be understood that blocks 620 and 622 may occur simultaneously. Eventually, the data is read to be delivered to the host device at block 624, which should be at the exact moment that the lane(s) are awake, at which point completion of the read command has occurred.

Thereafter, an assessment of the wake up time is made at block 626. If the wake up time is accurate, then the controller determines if there are any additional read commands to fetch at block 630, which is also what occurs after block 610. If the wake up time is not accurate, then the controller adjusts the wake up time at block 628 and then continues to block 630. The adjustment involves updating the information stored from block 602 so that going forward, the adjusted wake up time is utilized.

If there are no read commands to fetch at block 630, then a determination is made at block 632 regarding whether any lanes should be switched to electrically idle. If no lanes should be switched, then the process returns to block 630, but if there are lands to electrically idle, then a L0p lane idle request is sent at block 634 and the process returns to block 630.

If there are read commands to fetch at block 630, then a determination is made at block 636 regarding whether any lane can be moved to electrically idle. If no lane(s) can be moved to electrically idle, then the controller fetches a read command from the host device at block 604. If at least one lane can be moved to electrically idle, then at block 638 a L0p lane change request is sent and then a read command is fetched from the host device at block 604.

By triggering the L0p exit request ahead of time, taking into account the L0p exit latency advertised by the host link partner, the data storage device controller optimizes performance and power consumption by effectively utilizing the L0p feature.

In one embodiment, a data storage device comprises: a memory device; and a controller coupled to the memory device, wherein the controller is configured to: record L0p exit latency of link partner, wherein the exit latency is a first period of time; initiate L0p request to save power; determine that data needs to be transferred to the link partner; initiate L0p exit request, wherein the initiation occurs at a second period of time, wherein the second period of time is before transferring the data to the link partner, and wherein the second period is equal to or greater than the first period of time; and transfer the data to the link partner. The controller is configured to determine that the first period of time has changed and record the changed first period of time. The controller comprises a L0p manager module. The L0p manager module comprises a timer. The L0p manager module is configured to maintain a table comprising data corresponding to time for events to occur. The events are selected from the group consisting of memory device sense time, start of memory device transfer time, end of memory device transfer time, entry to a decoder, entry to a RAID, entry to a decryption module, and entry to a HIM. The initiating the L0p exit request is triggered by the timer. The controller is configured to measure the exit latency of the link partner. The initiating the L0p request comprises requesting the link partner to move one or more lanes of the link into an electrical idle state. The controller is configured to determine whether a next data transfer time is more than the exit latency.

In another embodiment, a data storage device comprises: a memory device; and a controller coupled to the memory device, wherein the controller is configured to: maintain a link between a HIM and a host device, wherein the link comprises a plurality of lanes and wherein the link has an exit latency; determine whether one or more lanes of the plurality of lanes needs to be woken up; send a L0p exit request to the host device, wherein the sending occurs at a first point in time; and transfer data to the host device, wherein the transferring occurs as a second point in time, and wherein a difference between the second point in time and the first point in time is equal to or greater than the exit latency. The controller is configured to send a request to the host device to move one or more lanes of the plurality of lanes into an electrically idle state. The determining occurs after parsing a read command and wherein the transferred data is for the read command. The controller is configured to receive the exit latency from the host device, wherein the controller is configured to determine accuracy of the exit latency received from the host device, and wherein the controller is configured to dynamically adjust the exit latency based upon the determined accuracy. The controller comprises a L0p manager module, wherein the L0p manager module comprises a timer, and wherein the L0p manager module is configured to initiate the sending of the L0p exit request. The controller is configured to manager L0p entry and exit timing based upon the exit latency and timing of events that occur during read command processing. The controller is configured to maintain a table of the timing of the events in a L0p manager module.

In another embodiment, a data storage device comprises: means for storing data; and a controller coupled to the means for storing data, wherein the controller is configured to: parse and schedule a read command; compare L0p exit latency to values in a table containing time before seeing traffic on a link; determine a point in time for sending a L0p exit request to a host device, wherein the point in time is during execution of the read command and before data for the read command reaches a HIM; send the L0p exit request to the host device; and send the data for the read command to the host device. A difference between a first time when the sending of the data for the read command to the host device and a second time when sending the L0p exit request to the host device is equal to or greater than the L0p exit latency. The controller is configured to dynamically adjust the L0p exit latency.

While the foregoing is directed to embodiments of the present disclosure, other and further embodiments of the disclosure may be devised without departing from the basic scope thereof, and the scope thereof is determined by the claims that follow.

What is claimed is:

1. A data storage device, comprising:
a memory device; and
a controller coupled to the memory device, wherein the controller is configured to:
record L0p exit latency of link partner, wherein the exit latency is a first period of time;
initiate L0p request to save power;
determine that data needs to be transferred to the link partner;
initiate L0p exit request, wherein the initiation occurs at a second period of time, wherein the second period of time is before transferring the data to the link partner, and wherein the second period is equal to or greater than the first period of time; and
transfer the data to the link partner.

2. The data storage device of claim 1, wherein the controller is configured to determine that the first period of time has changed and record the changed first period of time.

3. The data storage device of claim 1, wherein the controller comprises a L0p manager module.

4. The data storage device of claim 3, wherein the L0p manager module comprises a timer.

5. The data storage device of claim 4, wherein the L0p manager module is configured to maintain a table comprising data corresponding to time for events to occur.

6. The data storage device of claim 5, wherein the events are selected from the group consisting of memory device sense time, start of memory device transfer time, end of memory device transfer time, entry to a decoder, entry to a redundant array of inexpensive/independent disks (RAID), entry to a decryption module, and entry to a host interface module (HIM).

7. The data storage device of claim 4, wherein the initiating the L0p exit request is triggered by the timer.

8. The data storage device of claim 1, wherein the controller is configured to measure the exit latency of the link partner.

9. The data storage device of claim 1, wherein the initiating the L0p request comprises requesting the link partner to move one or more lanes of the link into an electrical idle state.

10. The data storage device of claim 1, wherein the controller is configured to determine whether a next data transfer time is more than the exit latency.

11. A data storage device, comprising:
a memory device; and
a controller coupled to the memory device, wherein the controller is configured to:
maintain a link between a host interface module (HIM) and a host device, wherein the link comprises a plurality of lanes and wherein the link has an exit latency;
determine whether one or more lanes of the plurality of lanes needs to be woken up;
send a L0p exit request to the host device, wherein the sending occurs at a first point in time; and
transfer data to the host device, wherein the transferring occurs as a second point in time, and wherein a difference between the second point in time and the first point in time is equal to or greater than the exit latency.

12. The data storage device of claim 11, wherein the controller is configured to send a request to the host device to move one or more lanes of the plurality of lanes into an electrically idle state.

13. The data storage device of claim 11, wherein the determining occurs after parsing a read command and wherein the transferred data is for the read command.

14. The data storage device of claim 11, wherein the controller is configured to receive the exit latency from the host device, wherein the controller is configured to determine accuracy of the exit latency received from the host device, and wherein the controller is configured to dynamically adjust the exit latency based upon the determined accuracy.

15. The data storage device of claim 11, wherein the controller comprises a L0p manager module, wherein the L0p manager module comprises a timer, and wherein the L0p manager module is configured to initiate the sending of the L0p exit request.

16. The data storage device of claim 11, wherein the controller is configured to manager L0p entry and exit timing based upon the exit latency and timing of events that occur during read command processing.

17. The data storage device of claim 16, wherein the controller is configured to maintain a table of the timing of the events in a L0p manager module.

18. A data storage device, comprising:
means for storing data; and
a controller coupled to the means for storing data, wherein the controller is configured to:
parse and schedule a read command;
compare L0p exit latency to values in a table containing time before seeing traffic on a link;
determine a point in time for sending a L0p exit request to a host device, wherein the point in time is during execution of the read command and before data for the read command reaches a host interface module (HIM);
send the L0p exit request to the host device; and
send the data for the read command to the host device.

19. The data storage device of claim 18, wherein a difference between a first time when the sending of the data for the read command to the host device and a second time when sending the L0p exit request to the host device is equal to or greater than the L0p exit latency.

20. The data storage device of claim 18, wherein the controller is configured to dynamically adjust the L0p exit latency.
